(19) United States
(12) Patent Application Publication
(10) Pub. No.: US 2006/0214140 A1
(43) Pub. Date: Sep. 28, 2006

(54) Hyperbranch polymer for nonlinear optics and material for nonlinear optics containing the same

(75) Inventors: Yasunari Nishikata, Kanagawa (JP); Yasuhiro Yamaguchi, Kanagawa (JP); Tomozumi Uesaka, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/211,408

(22) Filed: Aug. 25, 2005

(30) Foreign Application Priority Data
Mar. 24, 2005 (JP) 2005-87300

(51) Int. Cl. G02F 1/361

(52) U.S. Cl. 252/582

(57) ABSTRACT

The invention provides a hyperbranch polymer for nonlinear optics comprising a secondary nonlinear optically active dye atomic moiety that is regularly or irregularly bound to at least one selected from the group consisting of a branching unit of a hyperbranch polymer, a linear unit of a hyperbranch polymer and a terminal unit of a hyperbranch polymer. The invention further provides an organic functional material which comprises a hyperbranch polymer as defined above or a combination of plural hyperbranch polymers as defined above in a mixed state or in a chemically bound state. The organic functional material is excellent in function performance such as nonlinear optical function, amorphous property, heat resistance, and sublimation resistance.

### CROSS-REFERENCE TO RELATED APPLICATION

This application claims priority under 35 USC 119 from Japanese Patent Application No. 2005-87300, the disclosure of which is incorporated by reference herein.

### BACKGROUND OF THE INVENTION

1. Field of Invention

The present invention relates to an organic functional element that exhibits functions relating to light and/or electricity such as an organic electrophotographic photosensitive body which can be utilized in a copying machine, a printer, and an electronic paper; an organic electroluminescence element which can be utilized in an electronic display device and a display; and an organic nonlinear optical element which can be utilized in an optical modifier, an optical switch, an optical integrated circuit, an optical computer, an optical memory, a wavelength converting element, and a hologram element, which are useful in optical information communication and optical information processing. Further, the invention relates to an organic functional material which is a base material for forming the organic functional element.

2. Description of the Related Art

Many functional elements such as a wavelength converting element, an optical modifier, and an optical switch which are important in the fields of optical information communication, optical information processing and imaging using light are embodied by using a nonlinear optical material, in particular, a secondary nonlinear optical material. Inorganic nonlinear optical materials such as lithium niobate or potassium dihydrogen phosphate have been already put into practice and are widely used as secondary nonlinear optical materials. On the other hand, further to these inorganic materials, attention has been recently paid to organic nonlinear optical materials, which are superior in terms of high nonlinear optical performance, inexpensiveness of raw materials and low manufacturing costs or high productivity. Active research and development aimed at practical implementation of organic nonlinear optical materials has been conducted.

Achievement of a secondary nonlinear optical effect in principle requires the absence of a symmetrical center in a system thereof, and such systems are roughly classified into systems in which an organic compound having nonlinear optical activity is crystallized into a crystal structure having no symmetrical center (called a “crystal system”), and systems in which an organic compound having nonlinear optical activity is contained in or connected to a polymer binder, and the nonlinear optically active organic compound is oriented by any means (called a “polymer system”). A crystal system organic nonlinear optical material is known to be capable of exhibiting extremely high nonlinear optical performance. However, it is almost impossible to artificially control a crystal structure at present, and a crystal structure having no symmetrical center is rarely obtained. Even when such a crystal structure is obtained, it is difficult to form a large enough organic crystal to make an element. In addition, there is the problem that the strength of an organic crystal is so very brittle that it is damaged in the step of making an element therefrom. In contrast, since preferable properties such as film forming property and mechanical strength which are useful for making an element can be imparted to a polymer-based organic nonlinear optical material with a binder polymer, the potential of the polymer-based organic nonlinear optical material as regards practical implementation is deemed to be high and is considered to be promising.

A nonlinear optically active organic compound in a polymer-based organic nonlinear optical material is required to be uniformly dispersed in or connected to a polymer binder at a high concentration without being aggregated, so that the material is optically uniform and transparent. Further, in order to exhibit the secondary nonlinear optical effect described above, a nonlinear optically active organic compound must be oriented by any means, and isotropy must be imparted thereto. When the material is utilized in a functional element, its orientation must be stably maintained for a long period of time under the temperature and humidity environment in which an element is placed.

Therefore, a nonlinear optically active organic compound used in a polymer-based organic nonlinear optical material is required to have a low aggregating property and excellent compatibility with a binder polymer in addition to a high nonlinear optical performance. In addition, a polymer-based organic nonlinear optical material is generally made into an element in the form of a thin film, and a wet coating method is suitably used as a method of forming the thin film. For this reason, a nonlinear optically active organic compound used in a polymer-based organic nonlinear optical material is required to have a high solubility in a coating solvent. On the other hand, a binder polymer is required to have a high glass transition temperature for stably maintaining the orientation of a nonlinear optically active organic compound contained therein, in addition to a high film forming property and mechanical strength.

In order to induce secondary nonlinear optical activity in a polymer-based organic nonlinear optical material, it is necessary to orient a nonlinear optically active organic compound as described above. An electric field poling method is generally used as the orienting method. An electric field poling method is an orienting method including applying an electric field to a nonlinear optical material so as to orient a nonlinear optically active compound in a direction of the applied electric field by a Coulomb force caused by a dipole moment of the nonlinear optically active compound and the applied electric field. The electric field poling method generally promotes a molecular motion of a nonlinear optically active compound by heating it to near a glass transition temperature in addition to application of the electric field.

An organic pyroelectric material (electret) has been already put into practice as a material which is subjected to such electric field orienting treatment, and it is used in microphones, headphones or the like. Examples of a representative material used in an electret include poly(vinylidene fluoride) (PVDF). PVDF is a crystalline material, and has a structure in which a microcrystal region of a ferroelectric is present in admixture with an amorphous region. When an electric field is applied, a large amount of pyroelectricity is exhibited by rotating a microcrystal in a direction of the electric field so as to orient it thereto.

On the other hand, the presence of such a microcrystal is not preferable, particularly in optical materials, since the presence thereof causes performance reduction such as loss due to scattering. Therefore, in these materials, it is required that molecules, which have a moment by themselves, are dispersed in an amorphous material uniformly and at a high concentration.

Meanwhile, it is known that a so-called push-pull π conjugated compound having an electron donating group on one end of a π-conjugated chain and an electron withdrawing group on another end is effective as a nonlinear optically active organic compound. Examples of such a representative known nonlinear optically active organic compound include Disperse Red 1 (generally abbreviated as “DR1”), which has a N-ethyl-N-(2-hydroxyethyl)amino group as an electron donating group at a 4-position of a diazobenzene structure as a π-conjugated chain and a nitro group as an electron withdrawing group at a 4″-position of the diazobenzene structure. However, since such a molecule has a large dipole moment, intermolecular interaction is great, solubility and/or dispersibility in a medium are not good, and it is generally difficult to introduce the molecule into the material at a high concentration.

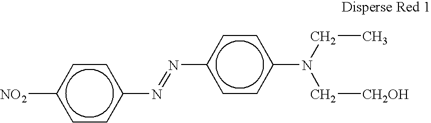

In particular, in order to satisfy the transparency required in an optical material, it is required that a medium polymer itself is also amorphous. An amorphous polymer is designed so that interaction between molecules or between repeating units is small in order to prevent crystallization, and the field formed thereby becomes nonpolar. Therefore, dispersibility of the aforementioned polar molecule into the field is generally greatly deteriorated.

On the other hand, it is understood that a nonlinear optical constant is proportionate to the number of molecules which can participate in this process in a unit volume of a medium, and in order to exhibit a large optical non linearity, it is vital to introduce a nonlinear optically active site into a medium so as to have a high concentration. However, it has been extremely difficult to realize such introduction by conventional techniques because of the aforementioned reasons.

In order to overcome the problems, various methods for introducing a nonlinear optically active dye cluster into a polymer itself at a high concentration have been developed.

One example of the introduction method is a process for synthesizing monomers having nonlinear optically active dye clusters and polymerizing them. This method enables introduction of a nonlinear optically active dye cluster as designed. However, the resulting polymer regularly contains an atomic moiety which has high polarity and is highly bulky in most cases, and in many cases exhibits performance which is far different from that of the base material thereof.

For example, remarkable reductions in crystallization and solubility due to considerable increase in the polarity of a polymer and remarkable reductions in glass transition temperature due to the introduction of a bulky substituent are frequently observed. Therefore, this method cannot be a general method for introducing a nonlinear optically active site into a medium at a high concentration.

In addition, a method for introducing a nonlinear optically active dye cluster into an already-formed polymer chain or polymer medium by a high-molecular molecule-low-molecular molecule has been also studied. However, in this case, it often tends to be difficult to obtain a desired reaction rate, and there is a problem that the ratio of introducing a nonlinear optically active dye cluster cannot be as high as that of the aforementioned method. Furthermore, in respect of change in performance of a polymer due to introduction of an active site, this method also has the same problem as that of the aforementioned method. Therefore, this method cannot be a general method for solving the problem either.

### SUMMARY OF THE INVENTION

The present inventors intensively researched introduction of a nonlinear optically active dye cluster into a medium at a high concentration, and prevention of denaturation and, in particular, crystallization, of a medium. As a result, the present inventors found out that by utilizing a hyperbranch polymer as a means for overcoming them, the aforementioned problems can be solved, which resulted in completion of the invention.

Namely, the present invention provides a hyperbranch polymer for nonlinear optics comprising a secondary nonlinear optically active dye atomic moiety that is regularly or irregularly bound to at least one selected from the group consisting of a branching unit of a hyperbranch polymer, a linear unit of a hyperbranch polymer and a terminal unit of a hyperbranch polymer.

Specifically, the secondary nonlinear optically active dye atomic moiety comprises a compound represented by the following Formula (1).

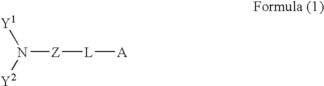

In Formula (1), L represents a π electron conjugated system; A represents an atomic moiety which exhibits an electron withdrawing property; Y¹ and Y² each independently represent a substituted or unsubstituted aliphatic group or a substituted or unsubstituted aromatic group; Z represents a substituted or unsubstituted aromatic group; and any of Y¹, Y², Z and L may be taken together to form a ring structure.

The present invention further provides an organic functional material which comprises the hyperbranch polymer or a combination of plural of the hyperbranch polymers in a mixed state or in a chemically bound state.

### BRIEF DESCRIPTION OF THE DRAWINGS

FIG. 1 is a conceptual view of a molecular structure of a hyperbranch polymer;

FIG. 2 conceptually shows structural units constituting a molecule of a hyperbranch polymer;

FIG. 3 is a schematic view showing formation of a hyperbranch polymer from AB2 monomers;

FIG. 4 is a schematic view showing formation of a hyperbranch polymer from A₂ monomers and B₃ monomers; and

FIG. 5 is a conceptual view of a molecular structure of a dendrimer.

### DETAILED DESCRIPTION OF THE PREFERRED EMBODIMENTS

The present invention will be explained in detail below in line with embodiments thereof.

Hyperbranch Polymer for Nonlinear Optics

First, the inventors devised the use of an artificially-constructed macromolecule or a nanoparticle which has a diameter of a few tens of nanometers or smaller as a means for introducing a nonlinear optically active dye cluster into a medium at a high concentration. The molecules or particles are provided based on an idea that they are much smaller in size when compared with a wavelength, and thus there is no fear that the quality of an optical material is deteriorated with respect to, for example, the center of light scattering.

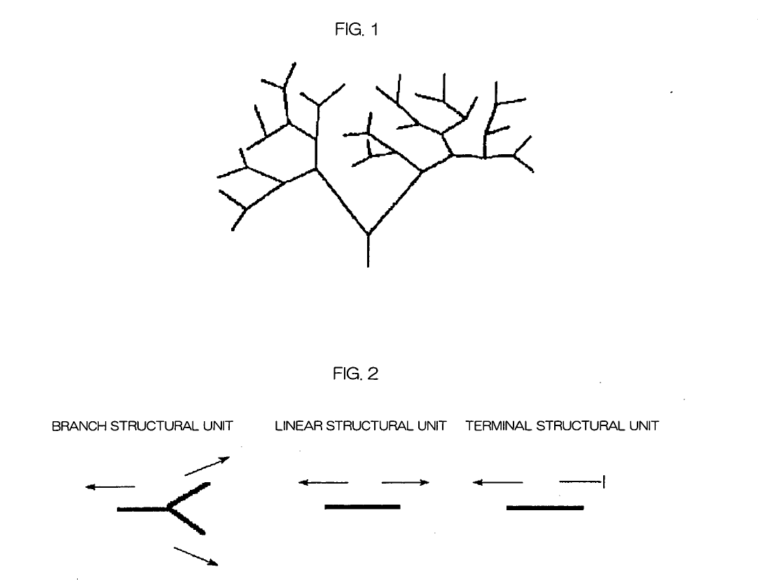

Second, the inventors devised the use of a hyperbranch polymer as the macromolecule. FIG. 1 shows a conceptual view of a hyperbranch polymer. This hyperbranch polymer is constructed of three units—a branching unit, a linear unit, and a terminal unit—as shown in FIG. 2. An arrow in FIG. 2 conceptually shows the direction of an elongation reaction of a polymer, and the mark ----| conceptually shows a site where a termination reaction occurs.

Each structural unit is synthesized by an organic chemistry procedure, respectively, and a nonlinear optically active dye cluster can be introduced thereto. The structural units can be polymerized as a hyperbranch polymer by conventional polymer synthesizing procedures.

The hyperbranch polymer herein obtained has the following characteristics as compared with conventional linear polymers, branched polymers, and crosslinked polymers.

(1) A molecular chain of the hyperbranch polymer is denser than that of conventional polymers. Therefore, the concentration of a nonlinear optically active dye cluster can be greatly increased by introducing the nonlinear optically active dye cluster into a polymer chain of the hyperbranch polymer.

(2) When the concentration of a nonlinear optically active dye cluster is so high as to cause disadvantages such as problems of loss of light due to absorption or generation of heat, these problems can be overcome by copolymerization of a suitable unit which does not contain a nonlinear optically active dye cluster therewith.

(3) Due to the presence of a dense branched structural unit, the extent of the suppression of molecular chain movement is great. That is, connection and orientation between nonlinear optically active dye clusters are greatly suppressed. As a result, weakening of intermolecular nonlinear optical activity at the orientation of the electric field and crystallization are suppressed.

(4) Individual molecules of a hyperbranch polymer are small in size as compared with a so-called microgel, and generally have better solubility in a solvent.

(5) A hyperbranch polymer itself is of a size which enables lengthening of the time necessary for phase separation and mixing of the polymer into a material system which was originally non-compatible.

(6) Due to the presence of a branched structure, the molecular size of the hyperbranch polymer is compact as compared with the molecular weight thereof, and entanglement of molecules thereof is reduced. As a result, it is generally thought that its solubility in a solvent is dramatically improved as compared with that of a conventional linear polymer. Further, for example, the viscosity of the hyperbranch polymer exhibited in a solution state or a melt state is lower as compared with that of a linear polymer which has a similar molecular weight as that of the hyperbranch polymer. This property greatly improves the processibility of the hyperbranch polymer.

(7) For a similar reason as in (6), the compatibility of the hyperbranch polymer is generally improved as compared with a linear polymer which has a similar molecular weight as that of the hyperbranch polymer. By utilizing this property, it is easy to impart a desired physical property thereto by a polymer blending procedure. For example, it is possible to adjust physical properties such as glass transition temperature, refractive index, or an interface property such as adherability or planarity so as to improve them.

(8) Since the size of a whole molecule is larger as compared with that of a nonlinear optically active dye cluster, it becomes difficult for rearrangement after electric field orientation to occur. As a result, stability over time is improved.

(9) It is possible to introduce various atomic moieties, which are not involved in an elongation reaction of the polymer, into a terminal structural unit of the polymer. Thereby, it is possible to impart various functions to the resulting polymer. Specific examples of the function include imparting a crosslinking property, improvement in compatibility, refractive index adjustment, cracking prevention, and electrification prevention, and thereby further improvements in function of the resulting element can be expected.

The hyperbranch polymer for nonlinear optics of the invention can be simply and easily synthesized by using conventionally-known or newly-synthesized compounds which have a nonlinear optically active dye cluster and 2 or more functional groups which are active in a polymerization reaction and applying to the functional groups a suitable conventionally known reaction to synthesize a hyperbranch polymer, a reaction of a linear polymer, or the like.

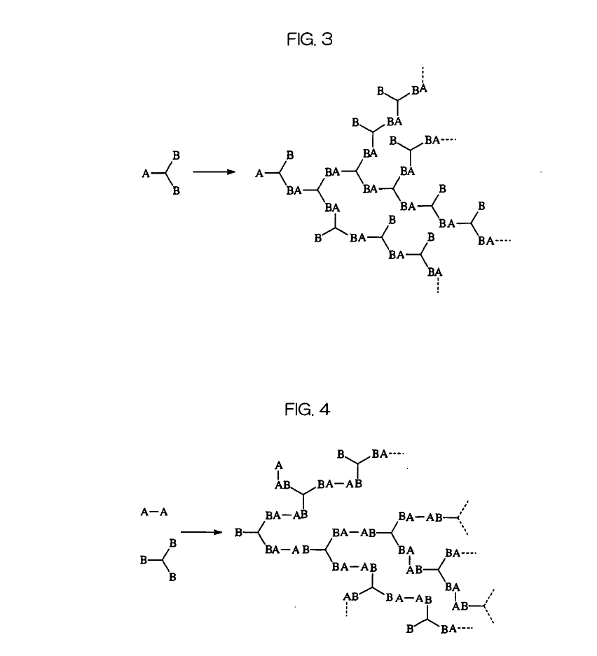

For example, when A and B are atomic moieties which can be reacted with each other to bind, a hyperbranch polymer can be obtained from a monomer having one A and two Bs in a molecule (an AB₂ monomer) by a reaction scheme shown in FIG. 3.

In addition, a hyperbranch polymer can be obtained from a monomer having two As in a molecule (an A₂ monomer) and a monomer having three Bs (a B₃ monomer) by a similar reaction scheme, as shown in FIG. 4.

It is generally known that a hyperbranch polymer is also produced by a reaction of an ABₙ (n≧3) monomer or a reaction of an A₂ monomer and a Bₙ (n≧3) monomer.

Examples of a skeleton of the hyperbranch polymer include those described in “Dendritic Macromelecules” (written by Masa-aki Kakimoto in KOUBUNSHI/High Polymers, Japan vol. 47, p. 804, 1998), “Synthesis and Structure Properties of Hyperbranch Polymers” (written by M. Kakimoto and M. Jikei in “Nanotechnology of Branched Polymers” edited by Koji Ishizu, IPC, 2000), “Synthesis of Hyperbranched Aromatic Polymers from Self-polycondensation of ABn Type Monomers” (in “Precision Polymers and Nano-Organized Systems” edited by T. Kunitake, S. Nakahama, S. Takahashi and N Toshima, pp. 147-150, Kodansha, 2000) and Japanese Patent Application Laid-Open (JP-A) No. 2001-98071. Some examples will be shown below, but the invention is not limited thereto. Structures exemplified below show products produced from an AB₂ monomer, but these polymers can be obtained by a reaction of an ABₙ (n≧3) monomer, or a reaction of an A₂ monomer and a Bₙ (n≧2) monomer.

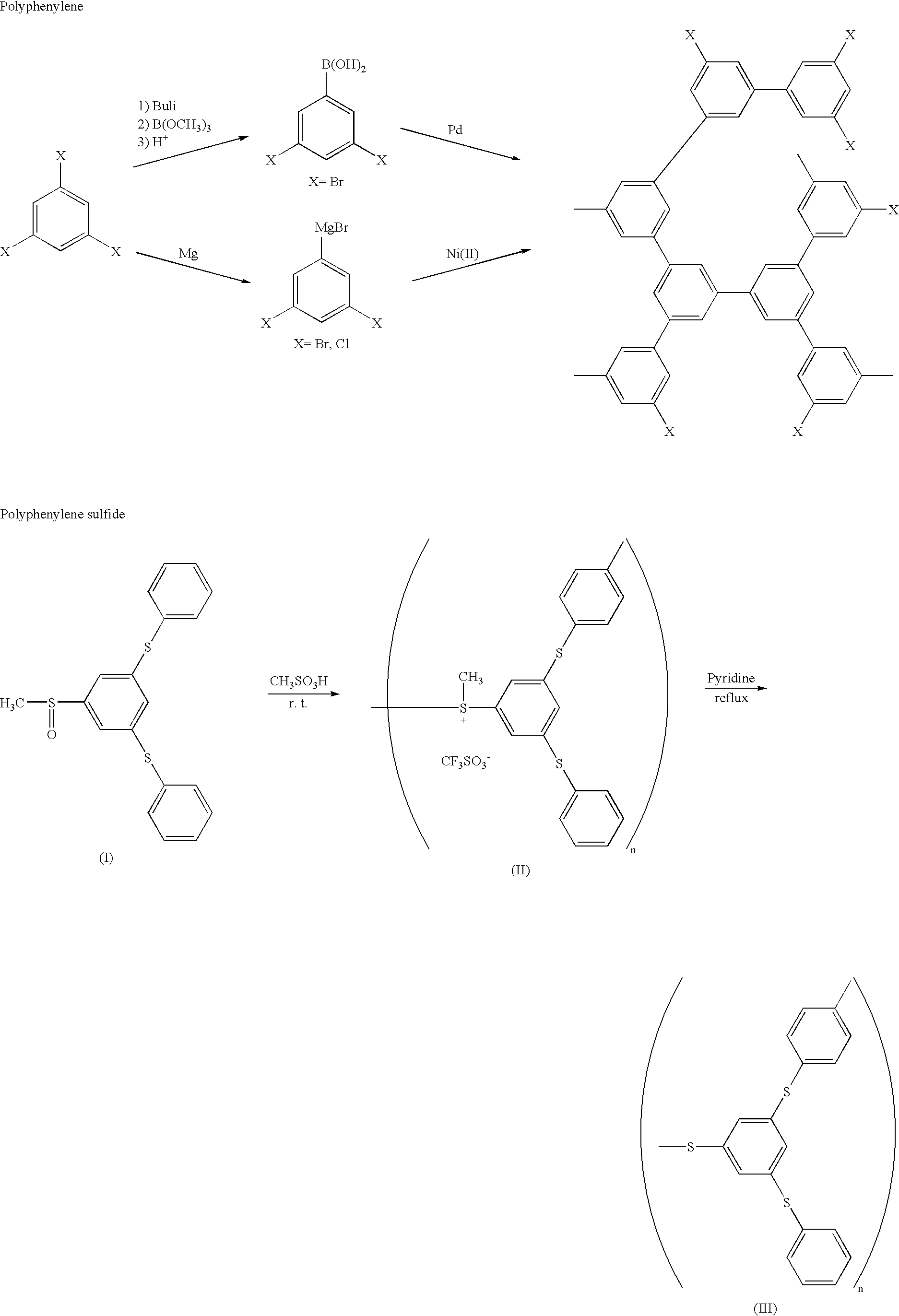

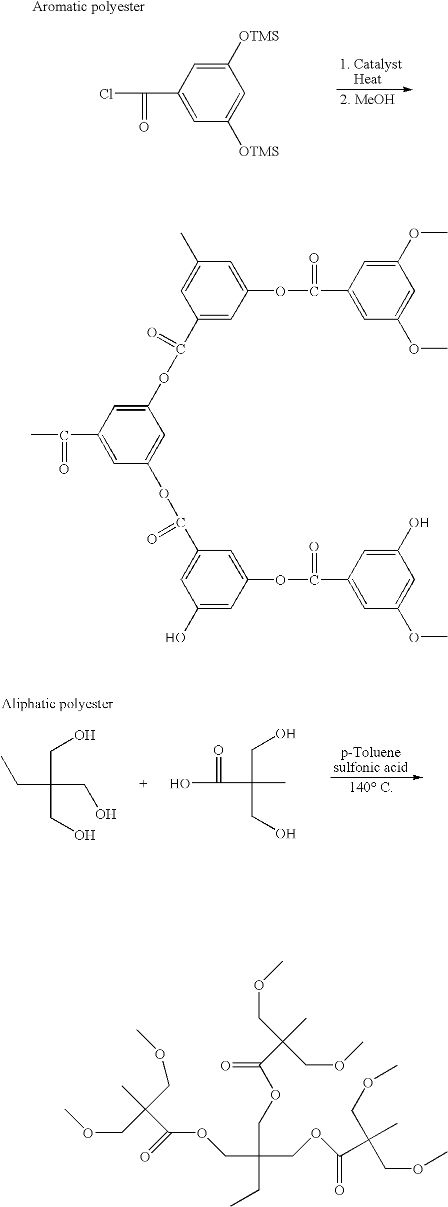

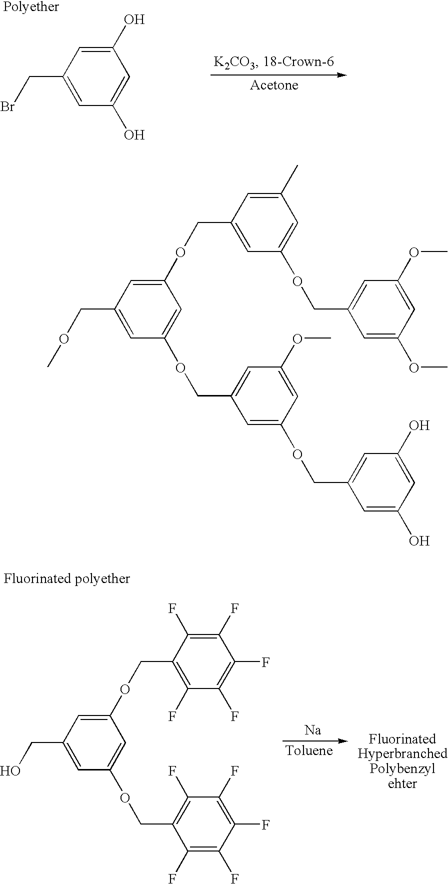

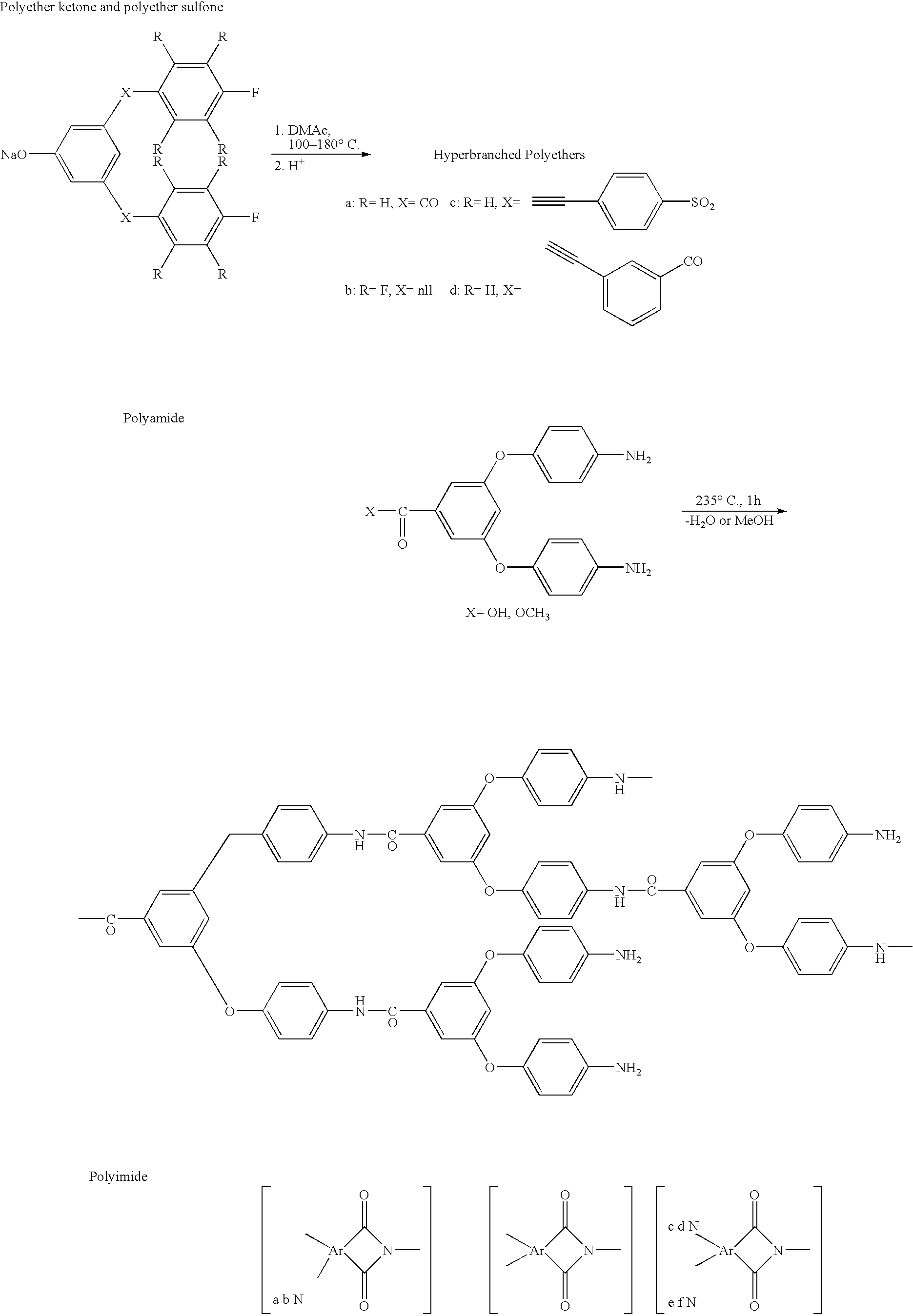

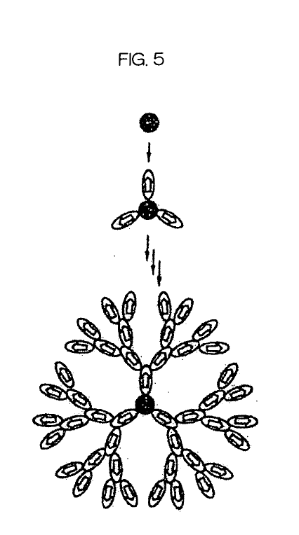

As a polymer having a branched structure similar to that of the hyperbranch polymer, a dendrimer shown in FIG. 5 is known. This is synthesized by performing respective reactions of a hyperbranch polymer stage by stage while insufficiently reacted polymers and excessive monomers are removed by purification. Since packing of the molecular chain thereof is dense, and entanglement of molecular chains is small, the dendrimer exhibits properties common to those of a hyperbranch polymer such as excellent solubility. In addition, since a molecule thereof is near a true sphere and the molecular weight distribution thereof is very narrow (ideally, there is no molecular weight distribution), the dendrimer exhibits properties which are partially superior to those of a hyperbranch polymer. For example, the viscosity of the dendrimer at dissolution or melting state is lower than that of a hyperbranch polymer having a similar branch structure, the volatility of the viscosity of the dendrimer is smaller than that of a hyperbranch polymer having a similar branch structure, and other molecules can make a complex with the dendrimer since pores having a controlled diameter are contained in a molecule of the dendrimer. Application of the dendrimer to a nonlinear optical material utilizing these properties has been proposed prior to such for a hyperbranch polymer (see, for example, Yokoyama et al., “Nonlinear Optical Properties of Dipolar Dendrimer”, KOUBUNSHI/High Polymers, Japan, vol. 47, p. 828 (1988)).

On the other hand, the dendrimer is synthesized by repetition of a cycle of reaction and purification. For this reason, there are many practical problems, and examples thereof include the very low productivity due to the necessity of synthesis having many stages, an economical problem which arises in some cases due to a low utilization efficiency of monomers, and difficulties in purification in a step of a reaction which has progressed to a certain extent, due to the high similarity in chemical properties between a reaction product and an unreacted substance. In view of the above, the inventors overcame problems possessed by the dendrimer-based material by utilizing a hyperbranch polymer which is easily synthesized and is excellent in economical property.

The organic functional material of the invention is characterized in that it contains the aforementioned hyperbranch polymer for nonlinear optics. Though the material may be utilized as a single crystal, a polycrystal, or an amorphous solid of a hyperbranch polymer alone, the material is generally preferably used as a composite material in which a hyperbranch polymer is dispersed in or connected to a polymer binder in view of the necessity of film forming property and mechanical strength upon preparation of an element.

Binder Polymer

Any binder polymer may be used in the invention as long as it is excellent in optical quality and film forming property. Preferable examples thereof include a binder polymer having a glass transition temperature of about 100° C. or higher. Particularly preferable examples thereof include a binder polymer having a glass transition temperature of about 140° C. or higher and a high mechanical strength, and specific examples thereof include a polyimide, a polycarbonate, a polyarylate, and a poly-cyclic olefin. Since the hyperbranch polymer is compact in molecular size and is small in entanglement of molecular chains as compared with a straight polymer having a molecular weight which is similar to the hyperbranch polymer, it is generally known that the hyperbranch polymer has high solubility in and high compatibility with various media. By utilizing this property, it is possible to use polymers, which are generally recognized as being difficult to use as binder polymers, in a system of the invention.

Further, a separately synthesized hyperbranch polymer having no nonlinear optical property may be also suitably utilized as a binder polymer.

Organic Functional Material

The hyperbranch polymer is provided as an organic functional material in a state where microcrystals are contained in a binder polymer, or in a state where the hyperbranch polymer is dispersed as amorphous molecules. When the hyperbranch polymer is applied to an element utilizing a function related to light, it is preferable that the hyperbranch polymer is in the dispersed amorphous molecule state from the viewpoint of optical qualities such as transparency. Alternatively, the hyperbranch polymer may be chemically bonded to a side chain or a main chain of the binder polymer.

The organic functional material of the invention may have any form. When the material is applied to a nonlinear optical element, the material is generally utilized in the form of a thin film. Examples of a method for forming a thin film containing the organic functional material of the invention include conventionally known processes such as an injection molding method, a press molding method, a soft lithography method or a wet coating method. From the viewpoint of simplicity, mass productivity, and film quality (evenness in film thickness, smallness of defects such as air bubbles, and the like) of a manufacturing apparatus, a wet coating method for forming a film by coating a solution obtained by dissolving at least the aforementioned organic functional material singly or, if necessary, in combination with a binder polymer in an organic solvent on a suitable substrate by a process such as a spin-coating method, a blade coating method, an immersion coating method, an ink jet method or a spray method.

Any organic solvent may be used as an organic solvent used in the wet coating method provided that it can dissolve the hyperbranch polymer and the binder polymer used in the invention. Preferable examples of the organic solvent include those having a boiling point in a range of about 100 to 200° C. When an organic solvent having a boiling point lower than about 100° C. is used, problems such as occurrence of a solvent volatilization during storage of a coating solution thus changing (increase) the viscosity thereof, or generation of dew condensation due to an excessively rapid volatilization rate tend to become prominent. On the other hand, when an organic solvent having a boiling point in excess of about 200° C. is used, problems such as reduction in the glass transition temperature caused by an effect of a remaining organic solvent, which works as a plasticizer for the polymer binder, may arise in some cases due to the difficulty of removing the solvent after coating. Examples of a preferable organic solvent include diethylene glycol dimethyl ether, cyclopentanone, cyclohexanone, cyclohexanol, toluene, chlorobenzene, xylene, N,N-dimethylformamide, N,N-dimethylacetamide, and dimethyl sulfoxide. These organic solvents may be used alone or in combination by mixing a plurality thereof. Alternatively, a mixed solvent obtained by adding an organic solvent having a boiling point of lower than about 100° C. such as tetrahydrofuran, methyltetrahydrofuran, dioxane, methyl ethyl ketone, isopropanol or the like to these preferable organic solvents may be also utilized.

The content of the hyperbranch polymer in the organic functional material of the invention is varied depending on the kind, required function performance and required mechanical strength of the hyperbranch polymer used and thus cannot be unconditionally defined, but generally, the content is preferably in a range of about 1 to 90% by weight based on the total weight of the organic nonlinear optical material. When the content is less than about 1% by weight, sufficient functional performance is not obtained in many cases, and when the content exceeds about 90% by weight, sufficient mechanical strength tends not to be obtained. A more preferable range of the content of the hyperbranch polymer is about 10 to 75% by weight, and a further preferable range thereof is about 25 to 60% by weight.

In addition to the aforementioned hyperbranch polymer and binder polymer, various additives may be added to the organic functional material of the invention as needed. For example, conventionally known antioxidants such as 2,6-di-t-butyl-4-methylphenol or hydroquinone may be added for the purpose of suppressing oxidation deterioration of a hyperbranch polymer and/or a binder polymer. Conventionally known ultraviolet-ray absorbing agents such as 2,4-dihydroxybenzophenone, or 2-hydroxy-4-methoxybenzophenone may be added for the purpose of suppressing ultraviolet-ray deterioration of a hyperbranch polymer and/or a binder polymer. When a wet coating method is used, conventionally known leveling agents such as a silicone oil may be added to the coating solution for the purpose of improving the surface smoothness of a coated film. Further, when a hyperbranch polymer and/or a binder polymer having a crosslinking-curing functional group is used, conventionally known curing catalysts or curing assistants may be added for the purpose of promoting the crosslinking curing.

In order to induce secondary nonlinear optical activity in a polymer-based organic nonlinear optical material, it is necessary to orient a nonlinear optically active organic compound as described above. Examples of the orienting method include a method of coating a polymer-based organic nonlinear optical material on a substrate having an oriented film on a surface thereof, and inducing orientation of a nonlinear optically active organic compound in the polymer-based organic nonlinear optical material by means of the orientation of the substrate oriented film. Alternatively, conventionally known poling methods such as an optical poling method, an optical assisted electric field poling method, an electric field poling method or the like may be also effectively utilized. Among them, an electric field poling method is particularly preferable in view of the simplicity of a device, the high degree of the resulting orientation and the like.

The electric field poling method is broadly divided between a contact poling method including holding a nonlinear optical material between a pair of electrodes and applying an electric field, and a corona poling method including applying corona discharge to a surface of a nonlinear optical material on a substrate electrode and applying an electrification electric field. The electric field poling method is an orienting method which orients a nonlinear optically active compound in an applied electric field direction by a Coulomb force formed by a dipole moment of a nonlinear optically active compound and an applied electric field. In general, the electric field poling method includes heating a nonlinear optical material to a temperature close to the glass transition temperature of the nonlinear optical material in the state where the electric field is applied so as to promote an orientation transfer of a nonlinear optically active compound in an electric field direction so as to induce a sufficient orientation, cooling the nonlinear optical material to room temperature while maintaining application of the electric field thereto so as to freeze the orientation, and removing the applied electric field. However, since this orientation is basically in a thermodynamically non-equilibrated state, a system in which a nonlinear optically active compound is dispersed in or connected to a linear polymer has the fundamental problem that gradual randomization occurs in accordance with the passage of time so as to reduce nonlinear optical performance even at a temperature not higher than the glass transition temperature of the nonlinear optically active compound. Since molecular chains of the hyperbranch polymer in a system of the invention are aligned more densely as compared with those of a linear polymer, and since free volume near a nonlinear optical material of the hyperbranch polymer is small, randomization of the orientation in accordance with the passage of time is remarkably reduced.

Organic Functional Element

The organic functional element of the invention is characterized in that the functions possessed by the organic functional material of the invention are utilized therein. Specific examples of the organic functional element include an organic electrophotographic photosensitive body utilizing a charge transporting function and/or charge generating function; an electroluminescence element utilizing a charge transporting function and/or electroluminescence function; a laser element or an optical amplification element utilizing a photoluminescence function; and a nonlinear optical element utilizing a nonlinear optical function such as a higher harmonic generating function, an electrooptical function, a photorefractive function or the like. Since the organic functional material of the invention has particularly excellent nonlinear optical performance, an organic nonlinear optical element which uses the organic functional material of the invention having a nonlinear optical element nonlinear optical function is particularly preferable as the organic functional element of the invention.

Any element may be used as an organic nonlinear optical element provided that it works based on a nonlinear optical effect, and examples thereof include a higher harmonic generating element, a wavelength converting element, a photorefractive element, and an electrooptical element. Particularly preferable examples thereof include electrooptical elements such as an optical switch, an optical modifier, phase shifting equipment or the like.

An electrooptical element is preferably utilized as an element having a structure in which a nonlinear optical material is formed as a waveguide structure on a substrate and is held between a pair of electrodes for an input electric signal.

Examples of a material constituting such a substrate include metals such as aluminum, gold, iron, nickel, chromium, titanium or the like; semiconductors such as silicon, gallium-arsenic, indium-phosphorus, titanium oxide, zinc oxide or the like; ceramics such as a glass; and plastics such as polyethylene terephthalate, polyethylene naphthalate, polycarbonate, polysulfone, polyether ketone, polyimide or the like.

An electrically conductive film may be formed on a surface of these substrate materials, and examples of a material for the electrical conductive film include metals such as aluminum, gold, nickel, chromium, titanium or the like; electrically conductive oxides such as tin oxide, indium oxide, ITO (tin oxide-indium oxide composite oxide) or the like; and electrically conductive polymers such as polythiophene, polyaniline, polyparaphenylene vinylene, polyacetylene or the like. These electrically conductive films are formed utilizing conventionally known dry film forming methods such as deposition, sputtering or the like, or conventionally known wet film forming methods such as a spray coating method, an immersion coating method, an electrolysis precipitation method or the like. If necessary, a pattern may be further formed. An electrically conductive substrate or an electrically conductive film formed on the aforementioned substrate is utilized as an electrode at poling or when working as an element (hereinafter, abbreviated as “lower electrode”).

An adhesive layer for improving adherence between a film formed thereon and a substrate, a leveling layer for smoothing irregularities on a substrate surface, or any intermediate layer for providing these functions as a whole may be further formed on the substrate as needed. The materials for forming these films are not particularly limited, and examples thereof include conventionally known materials such as an acryl resin, a methacryl resin, an amide resin, a vinyl chloride resin, a vinyl acetate resin, a phenol resin, a urethane resin, a vinyl alcohol resin, and an acetal resin, or copolymers thereof; and a crosslinked material of a zirconium chelate compound, a titanium chelate compound, or a silane coupling agent, or an uncrosslinked material thereof.

The electrooptical element of the invention is preferably formed so that it contains a waveguide structure, and it is particularly preferable that the nonlinear optical material of the invention is contained in a core layer of a waveguide.

A cladding layer (hereinafter, abbreviated as “lower cladding layer”) may be formed between a core layer containing the nonlinear optical material of the invention and a substrate. Any layer may be used as this lower cladding layer as long as it has a lower refractive index than that of the core layer, and is not eroded upon formation of the core layer. Examples of the material include acryl resins, epoxy resins, and silicone resins which are UV curing or thermosetting resins, polyimide, and SiO₂.

After the core layer made of the nonlinear optical material of the invention is formed, a cladding layer (hereinafter, abbreviated as “upper cladding layer”) may be further formed thereon in a similar manner as the lower cladding layer. A slab-type waveguide having a construction of substrate-lower cladding layer-core layer-upper cladding layer is formed thereby.

Alternatively, after the core layer is formed, the core layer may be subjected to patterning by conventionally known methods using semiconductor process techniques such as reactive ion etching (RIE), photolithography, and electron beam lithography so as to form a channel waveguide or a ridge waveguide. Alternatively, by irradiating UV light or electron beams to a part of a core layer by patterning, a refractive index of an irradiated portion may be changed to form a channel waveguide or a ridge waveguide.

A basic electrooptical element can be formed by forming an electrode (hereinafter, abbreviated as “upper electrode”) for applying an input electric signal to a surface of an upper cladding layer on a desired region of the upper cladding layer.

Upon formation of a channel waveguide or a ridge waveguide as described above, a conventionally known device structure such as a linear type, Y branch type, directional binder type, and Mach-Zender type may be constructed as a pattern of a core layer, and this can be applied to conventionally known devices for optical information communication such as an optical switch, an optical modifier, or phase shifting equipment.

### EXAMPLES

The present invention will be explained in more detail by way of Examples, but the invention is not limited thereto.

### Example 1

4.96 g of Disperse Red-19 is taken into a 100 ml flask which is equipped with a nitrogen introducing tube and a magnetic stirrer. 15 ml of N,N-dimethylacetamide is added thereto, and the mixture is stirred and dissolved. 2.4 ml (about 1.8 g) of triethylamine is added thereto, and after the system becomes uniform, the system is cooled to 0° C. 2.65 g of trimesic acid chloride as a solid is added thereto, and the materials are reacted at 0° C. for 3 hours, and are further reacted at room temperature for 6 hours while the system is slowly stirred. After completion of the reaction, the system is placed into 500 ml of methanol, the produced reddish black solid is filtered off, washed well with methanol and water, and dried. Yield therefrom is 5.9 g (83%). A number average molecular weight of the resulting polymer is 1,600 as measured by GPC using N,N-dimethylformrnamide as a solvent. A calculated molecular weight between branches of the hyperbranch polymer is about 400. This polymer can be dissolved in N,N-dimethylacetamide, N,N-dimethylformamide, chloroform, o-chlorophenol, m-cresol or the like. An intrinsic viscosity value of the hyperbranch polymer measured using N,N-dimethylacetamide as a solvent is 0.07 dl/g (30° C.). 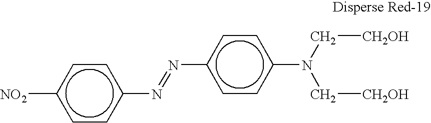
Hyperbranch Polymer of Example 1

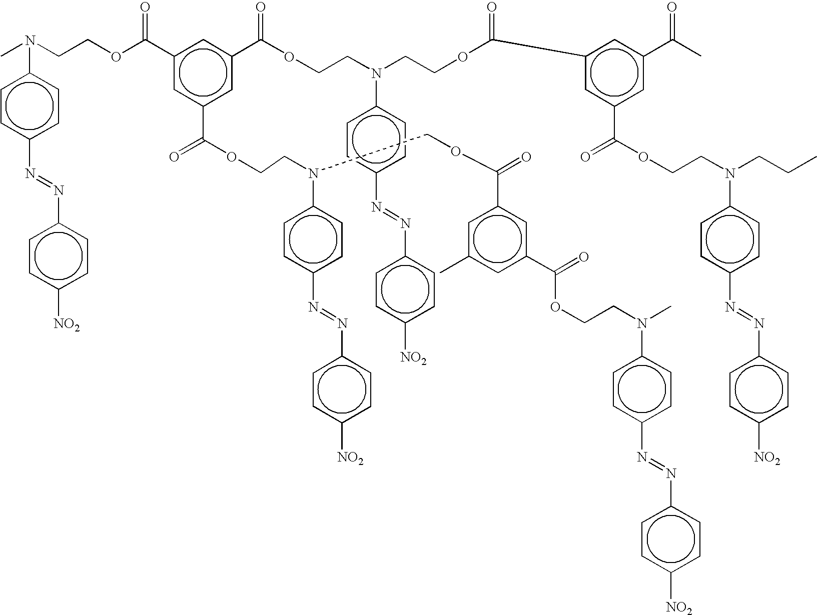

### Example 2

3.96 g of Disperse Red-19 is taken into a 100 ml flask equipped with a nitrogen introducing tube and a magnetic stirrer. 12 ml of N,N-dimethylacetamide is added thereto, and the mixture is stirred and dissolved. 1.6 ml (about 1.2 g) of triethylamine is added thereto, and after the system becomes uniform, the system is cooled to 0° C. 1.22 g of isophthalic acid chloride as a solid is added thereto, and the materials are reacted at 0° C. for 3 hours while the system is slowly stirred. Further, 0.53 g of trimesic acid chloride as a solid is added thereto, and the materials are reacted at 0° C. for 3 hours, and further reacted at room temperature for 6 hours while the system is slowly stirred. After completion of the reaction, 500 ml of methanol is placed into the system, and the produced reddish black solid is filtered off, washed well with methanol and water, and dried. Yield therefrom is 4.4 g (78%). A number average molecular weight of the resulting polymer is 2,000 as measured by GPC using N,N-dimethylformamide as a solvent. A calculated molecular weight between branches of this hyperbranch polymer is about 850. This polymer can be dissolved in N,N-dimethylacetamide, N,N-dimethylformamide, chloroform, o-chlorophenol, m-cresol or the like. An intrinsic viscosity value of the hyperbranch polymer measured using N,N-dimethylacetamide as a solvent is 0.09 dl/g (30° C.).
Hyperbranch Polymer of Example 2

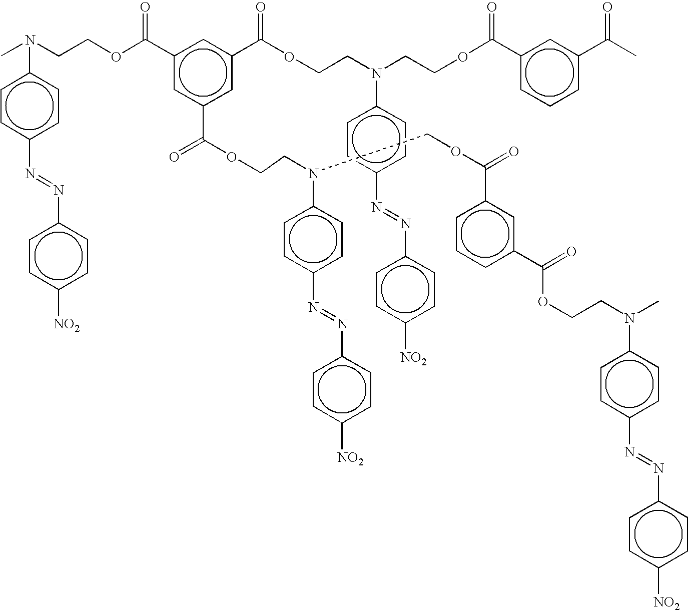

### Comparative Example 1

3.3 g of Disperse Red-19 is taken into a 100 ml flask equipped with a nitrogen introducing tube and a magnetic stirrer. 10 ml of N,N-dimethylacetamide is added thereto, and the mixture is stirred and dissolved. 1.6 ml (about 1.2 g) of triethylamine is added thereto, and after the system becomes uniform, the system is cooled to 0° C. 2.03 g of isophthalic acid chloride as a solid is added thereto, and the materials are reacted at 0° C. for 3 hours, and are further reacted at room temperature for 6 hours while the system is slowly stirred. After completion of the reaction, the system is placed into 500 ml of methanol, and the produced reddish black solid is filtered off, washed well with methanol and water, and dried. Yield therefrom is 3.8 g (83%). A number average molecular weight of the resulting polymer is 3,400 as measured by GPC using N,N-dimethylformamide as a solvent. A calculated molecular weight between branches of this polymer is infinite, and a length of a linear structural unit of this polymer is thought to be about 3,000 from an actually measured molecular weight. This polymer can be dissolved in N,N-dimethylacetamide, N,N-dimethylformamide, chloroform, o-chlorophenol, m-cresol or the like. An intrinsic viscosity value of the polymer as measured using N,N-dimethylacetamide as a solvent is 0.13 dl/g (30° C.).
Polymer of Comparative Example 1 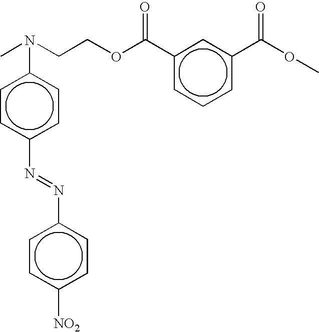
Comparative Example 2

1.98 g of Disperse Red 19 and 1.89 g of Disperse Red 1 are taken into a 100 ml flask equipped with a nitrogen introducing tube and a magnetic stirrer. 12 ml of N,N-dimethylacetamide is added thereto, and the mixture is stirred and dissolved. 1.3 ml (about 0.9 g) of triethylamine is added thereto, and after the system becomes uniform, the system is cooled to 0° C. 0.61 g of isophthalic acid chloride as a solid is added thereto, and the materials are reacted at 0° C. for 3 hours while the system is slowly stirred. Further, 0.265 g of trimesic acid chloride as a solid is added thereto, and the materials are reacted at 0° C. for 3 hours, and are further reacted at room temperature for 6 hours while the system is slowly stirred. After completion of the reaction, the system is placed into 500 ml of water, and the produced reddish black solid is filtered off, and dried. Yield therefrom is 1.8 g (48%). A number average molecular weight of the resulting polymer is 600 as measured by GPC using N,N′-dimethylformamide as a solvent. This polymer is a star-shaped polymer having three branches having two nonlinear optically active dye clusters and having a molecular weight from a central point of about 900, and it is presumed that the fraction of hyperbranch polymer therein is low. This polymer can be dissolved in N,N-dimethylacetamide, N,N-dimethylformamide, chloroform, o-chlorophenol, m-cresol or the like. An intrinsic viscosity value of the polymer as measured using N,N-dimethylacetamide as a solvent is 0.02 dl/g (30° C.).
Polymer of Comparative Example 2

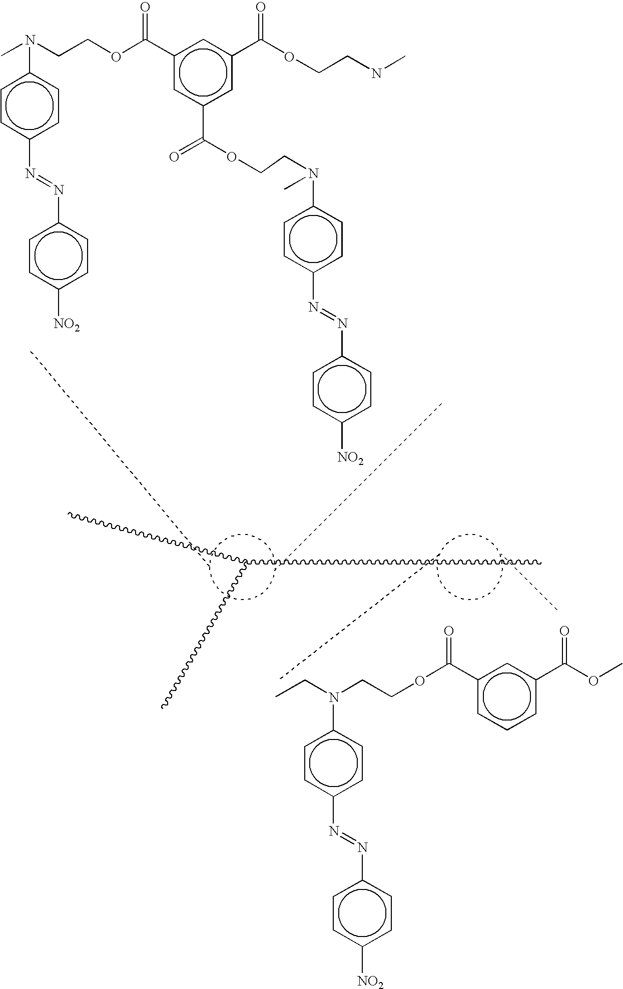

### Example 4

A solution obtained by dissolving 5 parts by weight of the hyperbranch polymer obtained in Example 1 and 5 parts by weight of the linear polymer obtained in Comparative Example 1 in 90 parts by weight of tetrahydrofuran (boiling point: 66° C.) is coated on a glass substrate provided with a gold parallel electrode pair (distance between electrodes: 20 μm) on a surface thereof by a spin-coating method, and this is dried at room temperature for 3 hours, and is further dried at 100° C. for 3 hours so as to obtain a thin film having a thickness of 0.1 μm.

Then, the thin film is retained at 170° C. for 15 minutes in a state where an electric field at 50 V/μm is applied between the electrodes, and the film is cooled to room temperature from that state while the electric field is continuously applied, and the electric field is then removed.

When semiconductor laser light having an oscillation wavelength of 1,550 nm is irradiated to the thus obtained thin film consisting of the organic nonlinear optical material of the invention which has been subjected to the electric field poling, generation of a secondary higher harmonic of 775 nm can be observed, and it is confirmed that it effectively functions as a nonlinear optical material. Further, after the nonlinear optical material is retained under a high temperature environment at 65° C. for 10 days and laser light is irradiated thereto again, generation of a secondary higher harmonic having an intensity which is about 80% of the intensity at the initial stage is confirmed, which proves that the present nonlinear optical material has high heat resistance and stability over time.

When the thin film is observed with an optical polarized microscope, it is very clear, and segregation of a nonlinear optically active dye cluster is not recognized.

### Example 5

A solution obtained by dissolving 5 parts by weight of the hyperbranch polymer obtained in Example 1 and 5 parts by weight of the linear polymer obtained in Comparative Example 2 in 90 parts by weight of tetrahydrofuran (boiling point: 66° C.) is coated on a glass substrate provided with a gold parallel electrode pair (distance between electrodes: 20 μm) on a surface thereof by a spin-coating method, and this is dried at room temperature for 3 hours, and is further dried at 100° C. for 3 hours so as to obtain a thin film having a thickness of 0.1 μm.

Then, the thin film is retained at 170° C. for 15 minutes in a state where an electric field at 50 V/μm is applied between the electrodes, and the film is cooled to room temperature from that state while the electric field is continuously applied, and the electric field is then removed.

When semiconductor laser light having an oscillation wavelength of 1,550 nm is irradiated to the thus obtained thin film consisting of the organic nonlinear optical material of the invention which has been subjected to the electric field poling, generation of a secondary higher harmonic of 775 nm can be observed, and it is confirmed that it effectively functions as a nonlinear optical material. Further, after the nonlinear optical material is retained under a high temperature environment at 65° C. for 10 days and laser light is irradiated thereto again, generation of a secondary higher harmonic having an intensity which is about 70% of the intensity at the initial stage is confirmed, which proves that the present nonlinear optical material has high heat resistance and stability over time.

When the thin film is observed with an optical polarized microscope, it is very clear, and segregation of a nonlinear optically active dye cluster is not recognized.

### Comparative Example 3

A solution obtained by dissolving 10 parts by weight of the straight polymer obtained in Comparative Example 1 in 90 parts by weight of tetrahydrofuran (boiling point: 66° C.) is coated on a glass substrate provided with a gold parallel electrode pair (distance between electrodes: 20 μm) on a surface thereof by a spin-coating method, and this is dried at room temperature for 3 hours, and is further dried at 100° C. for 3 hours so as to obtain a thin film of a thickness of 0.1 μm.

Then, the thin film is retained at 170° C. for 15 minutes in a state where an electric field at 50 V/μm is applied between the electrodes, and the film is cooled to room temperature from that state while the electric field is continuously applied, and the electric field is removed.

When semiconductor laser light having an oscillation wavelength of 1,550 nm is irradiated to the thus obtained thin film consisting of the organic nonlinear optical material of the invention which has been subjected to the electric field poling, generation of a secondary higher harmonic of 775 nm can be observed, and it is confirmed that it effectively functions as a nonlinear optical material. Further, after the nonlinear optical material is retained under a high temperature environment at 65° C. for 10 days and laser light is irradiated thereto again, generation of a secondary higher harmonic having an intensity which is about 50% of the intensity at the initial stage is confirmed.

When the thin film is observed with an optical polarized microscope, it is very clear, and segregation of a nonlinear optically active dye cluster is not recognized.

### Comparative Example 4

A solution obtained by dissolving 5 parts by weight of the hyperbranch polymer obtained in Comparative example 1 and 5 parts by weight of the linear polymer obtained in Comparative Example 2 in 90 parts by weight of tetrahydrofuran (boiling point: 66° C.) is coated on a glass substrate provided with a gold parallel electrode pair (distance between electrodes: 20 μm) on a surface thereof by a spin-coating method, and this is dried at room temperature for 3 hours, and is further dried at 100° C. for 3 hours so as to obtain a thin film having a thickness of 0.1 μm.

Then, the thin film is retained at 170° C. for 15 minutes in a state where an electric field at 50 V/μm is applied between the electrodes, and the film is cooled to room temperature from that state while the electric field is continuously applied, and the electric field is then removed.

When semiconductor laser light having an oscillation wavelength of 1,550 nm is irradiated to the thus obtained thin film consisting of the organic nonlinear optical material of the invention which has been subjected to the electric field poling, generation of a secondary higher harmonic of 775 nm can be observed, and it is confirmed that it effectively functions as a nonlinear optical material. Further, after the nonlinear optical material is retained under a high temperature environment at 65° C. for 10 days and laser light is irradiated thereto again, generation of a secondary higher harmonic having an intensity which is about 20% of the intensity at the initial stage is confirmed.

When the thin film is observed with an optical polarized microscope, luminescent spots are observed although they are very fine and there is only a small amount thereof.

As described above, the organic functional material of the invention is characterized in that a hyperbranch structure polymer having a particular structure and excellent in function performance such as nonlinear optical function, amorphous property, heat resistance, sublimation resistance or the like is dispersed in or connected to a polymer binder. Since the hyperbranch structure polymer takes a uniform dispersed state without being aggregated even at a high concentration, both of high optical quality and excellent function performance are provided. Further, since heat resistance and stability with time in the orientation are high in a nonlinear optical material, excellent performance can be retained over the long term. For these reasons, an organic functional element which is excellent in various properties and stability can be embodied by using the organic functional material of the invention.

What is claimed is:

1. A hyperbranch polymer for nonlinear optics comprising a secondary nonlinear optically active dye atomic moiety that is regularly or irregularly bound to at least one selected from the group consisting of a branching unit of a hyperbranch polymer, a linear unit of a hyperbranch polymer and a terminal unit of a hyperbranch polymer.

2. The hyperbranch polymer for nonlinear optics of claim 1, wherein the secondary nonlinear optically active dye atomic moiety comprises a compound represented by the following Formula (1): 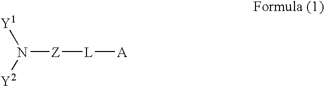
wherein, L represents a π electron conjugated system; A represents an atomic moiety which exhibits an electron withdrawing property; Y¹ and Y² each independently represent a substituted or unsubstituted aliphatic group or a substituted or unsubstituted aromatic group; Z represents a substituted or unsubstituted aromatic group; and any of Y¹, Y², Z and L may be taken together to form a ring structure.

3. The hyperbranch polymer for nonlinear optics of claim 2, wherein in the Formula (1), L is one selected from the group consisting of a single bond, a π conjugated group which may have a substituent contained in a ring structure, a π conjugated group which may have a substituent which directly binds to a ring structure, and a π conjugated group which may have a substituent adjacent to a ring structure.

4. An organic functional material which comprises a hyperbranch polymer or a combination of plural hyperbranch polymers in a mixed state or in a chemically bound state, wherein the hyperbranch polymer(s) comprises a secondary nonlinear optically active dye atomic moiety that is regularly or irregularly bound to at least one selected from the group consisting of a branching unit of a hyperbranch polymer, a linear unit of a hyperbranch polymer and a terminal unit of a hyperbranch polymer.

5. The organic functional material of claim 4, wherein another hyperbranch polymer which does not contain any other secondary nonlinear optically active dye atomic moiety is mixed or chemically bound to the hyperbranch polymer.

6. An organic functional material which comprises the organic functional material as defined in claim 4 in a polymer binder.

7. The organic functional material of claim 6, wherein the polymer binder is a thermoplastic resin.

8. The organic functional material of claim 7, wherein the polymer binder comprises at least one selected from the group consisting of polyimide, polyamide, poly(amidoimide), polyether, polycarbonate, polyester, polysulfone, polyether sulfide, polyether ketone and poly-cyclic olefin.

9. The organic functional material of claim 6, wherein the polymer binder is a thermosetting resin.

10. An organic functional element which comprises the organic functional material as defined in claim 4.

11. The organic functional element of claim 10, which works by a nonlinear optical function.

12. The organic functional element of claim 11, wherein the nonlinear optical function is a primary electrooptical effect.
